(19) United States
(12) Patent Application Publication
(10) Pub. No.: US 2007/0110982 A1
(43) Pub. Date: May 17, 2007

(54) Device having a hydrophobic and/or lipophobic surface and method of producing one such device

(75) Inventors: Marc Plissonnier, Eybens (FR); Franck Rouppert, St Pierre de Bressieux (FR); Frederic Gaillard, Voiron (FR); Emmanuelle Rouviere, Saint Egreve (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Commissariat A L'energie Atomique, Paris (FR)

(21) Appl. No.: 10/581,686

(22) PCT Filed: Dec. 16, 2004
(86) PCT No.: PCT/FR04/50707

§ 371 Date: Jun. 6, 2006

(30) Foreign Application Priority Data
Dec. 19, 2003 (FR) 0351137

(51) Int. Cl. B05D 1/36; B32B 5/02

(52) U.S. Cl. 428/300.1; 427/203

(57) ABSTRACT

The present invention relates to a device with a hydrophobic and/or lipophobic surface comprising a carpet of nanofibers (20), wherein these nanofibers (20) are totally cladded with a hydrophobic and/or lipophobic continuous film, and wherein the surface (22) between these nanofibers is covered with a layer of this same polymer. The invention also relates to a method for making such a device.

### TECHNICAL FIELD

The invention relates to a device with a hydrophobic surface, i.e., which repels water, does not absorb it or is not dissolved therein, and/or “lipophobic” surface, i.e., by analogy, which repels fatty substances, does not absorb them or is not dissolved therein, and a method for making such a device

### STATE OF THE PRIOR ART

Making super-hydrophobic surfaces is increasingly of interest because such surfaces find many fields of application.

Such surfaces may be obtained by changing their roughness and their surface energy.

Practically, geometrical patterns may be engraved on such surfaces by using photolithography or machining methods. It is then necessary to make these surfaces hydrophobic by grafting or depositing hydrophobic compounds. They may also be obtained by dispersing micrometric particles in a gel or a resin applied onto this surface. In this case, the particles are intrinsically hydrophobic.

Such surfaces may also be made hydrophobic by depositing nanofibers, i.e., fibers of nanometric size, on these surfaces, followed by a chemical reaction on these nanofibers.

An article “Super-Amphiphobic aligned carbon nanotube films” of Huanjun Li, Xianbao Wang, Yanlin Song, Yungi Liu, Qianshu Li, Lei Jiang, and Daoben Zhu (Angew. Chem. Int., Ed. 2001, 40, No. 9, pages 1743-1746) thus describes the growth of films consisting of aligned carbon nanofibers (NTC) positioned perpendicularly to the surface of a substrate, and packed closely, with a uniform length and diameter, and then the immersion of these nanofibers in a methanol solution of hydrolyzed fluoroalkylsilane.

FIG. 1 illustrates an exemplary device obtained from such carbon nanofibers 10 made hydrophobic by chemical reaction. As illustrated in this figure:

Each carbon nanofiber 10 is laid on the surface 11 and does not adhere to the latter.

Only the upper portion 12 of each carbon nanofiber 10 is made hydrophobic.

There is no continuity of treatment:
over the whole surface of each carbon nanofiber,
over the surface between the carbon nanofibers.

Such treatment non-continuity is mainly due to the means used for making the carbon nanofibers hydrophobic. The liquid reagent used cannot attain the whole surface of each carbon nanofibers 10 because of capillarity phenomena. Moreover, this liquid reagent does not react with carbon and not with the underlying surface.

In the presence of a steam condensation phenomenon, this steam is formed in priority on the surface 13 between the carbon nanofibers, which is not hydrophobic. This surface 13 is therefore automatically polluted by this condensation and the impurities conveyed by the latter.

The object of the invention is to improve hydrophobicity of such a device by using another method for depositing polymer film.

### DISCUSSION OF THE INVENTION

The invention relates to a device with a hydrophobic and/or lipophobic surface comprising a carpet of nanofibers, for example carbon nanofibers, characterized in that these carbon nanofibers are totally cladded with a hydrophobic and/or lipophobic continuous polymer film, for example polysiloxane, or a carbofluorinated polymer, and in that the surface between these nanofibers is covered with a layer of this same polymer.

The invention also relates to a method for making such a device with a hydrophobic and/or lipophobic surface which comprises a step for depositing nanofibers on a surface of said device, characterized in that it subsequently includes a step for cladding these nanofibers with a hydrophobic and/or lipophobic polymer achieved by a technique for dry physical deposition, or by an electro-grafting technique.

In an exemplary embodiment, the method of the invention includes the following steps:

a step for depositing carbon nanofibers on a surface of a part, which successively comprises:
depositing a catalyst by a PVD (Physical Vapor Deposition) method, the catalyst being deposited in vacuo at a pressure of a few 10⁻³ mbars, a target consisting of catalytic material being bombarded by a flux of ionized argon, the thereby ejected atoms from the target covering this surface,
introducing the thereby covered part into the chamber of a CVD oven in vacuo in order to achieve the deposition of carbon nanofibers, the catalyst being first of all transformed into drops under the effect of the rise in temperature of the part, a hydrocarbon precursor being subsequently introduced into this chamber, the growth of carbon nanofibers being performed at the location where the catalyst is transformed into drops.

a step for cladding the nanofibers with a hydrophobic polymer with a PECVD (Plasma Enhanced Chemical Vapor Deposition) technique, or by an electro-grafting technique.

With the present invention, it is possible to make hydrophobic nanofibers, with which very large contact angles of a liquid on a solid may be obtained: for example, larger than 160°.

The fields of applications of the invention are very wide. For example, these are the making of:

electrochemical electrodes for analytic analysis,

ink injection systems for printing on paper,

channels for distributing or retaining liquid in biological analysis Microsystems,

surfaces of pistons for injecting liquid food,

textured plates of heat exchangers,

biological sensors or microcavities in which fluids flow, requiring the presence of a hydrophobic surface.

Such a technology is also applicable to the requirements of self-cleaning and/or anti-condensation surfaces.

### SHORT DESCRIPTION OF THE DRAWINGS

FIG. 1 illustrates a device from the prior art provided with a hydrophobic surface.

FIG. 2 illustrates a device with a hydrophobic surface according to the invention.

FIG. 3 illustrates the shape of a drop of water deposited on the surface formed by the upper end of the nanofibers of the device of the invention.

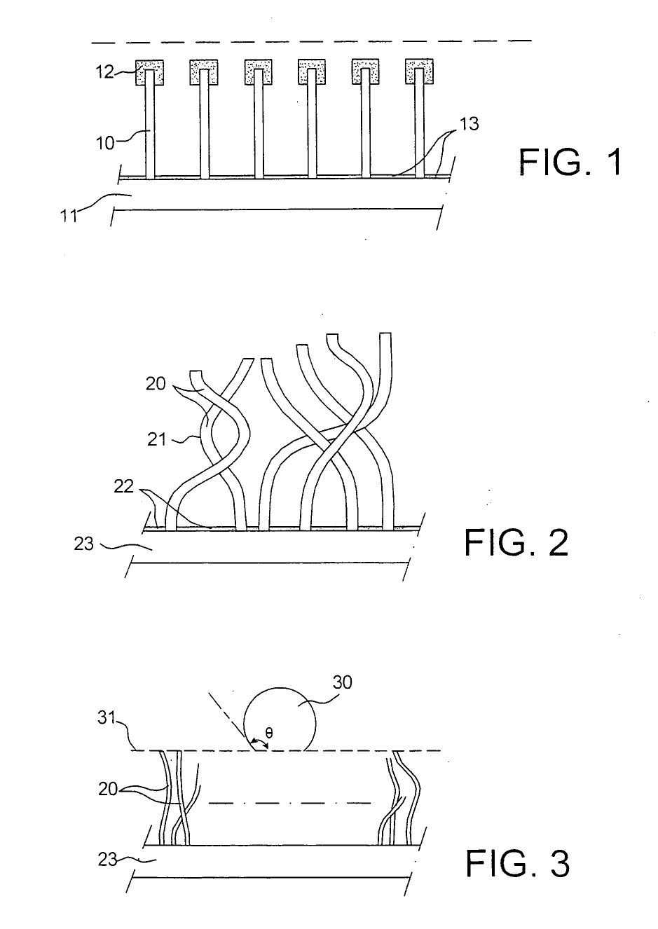

### DETAILED DISCUSSION OF PARTICULAR EMBODIMENTS

The device of the invention, as illustrated in FIG. 2, is a device with a hydrophobic and/or lipophobic surface comprising a carpet of nanofibers 20, which are totally cladded with a hydrophobic and/or lipophobic, continuous polymer film 21. The surface 22 existing between these nanofibers is itself covered with a layer of this same polymer.

Continuity of the polymer film allows the nanofibers to be bonded or firmly attached onto the surface 23.

The cladding may be achieved by a dry physical deposition technique or by an electrografting technique.

The following characteristics may thereby be obtained:

exemplary nanofibers used: carbon nanofibers

exemplary polymer film used: polysiloxane or carbofluorinated polymer

diameter of a nanofiber 20: about 20 to 30 nm

length of a nanofiber: about 3 μm

thickness of the hydrophobic polymer film: about 50 nm.

The method for making such a device with a hydrophobic and/or lipophobic surface thus comprises a step for depositing nanofibers on a surface of said device, and then a step for cladding these nanofibers with a hydrophobic and/or lipophobic polymer by means of a dry physical deposition technique or an electrografting technique.

FIG. 3 illustrates the shape of a drop of water 30 of about 1.5 mm in diameter deposited on the carpet of thereby treated carbon nanofibers 20 forming a hydrophobic surface. This drop 31 is slightly deformed by its weight, the actual contact angle θ for an undeformed drop therefore being larger than 175°.

In an exemplary embodiment of a super-hydrophobic layer, the following steps are performed:

a step for depositing a carpet of carbon nanofibers on a surface of a part, successively comprising:
depositing a catalyst by a PVD method, this catalyst being deposited in vacuo at a pressure of a few 10⁻³ mbars, a target consisting of a catalytic material being bombarded by a flux of ionized argon, the thereby ejected atoms of the target covering this surface,
introducing this thereby covered part into a CVD (Chemical Vapor Deposition) oven in vacuo in order to perform deposition of carbon nanofibers, the limiting vacuum being of a few 10⁻³ mbars, the catalyst being first of all transformed into drops under the effect of the rise in temperature of the part, a hydrocarbon precursor being then introduced into the chamber, the growth of carbon nanofibers being performed at the location where this catalyst is transformed into drops,

a step for cladding the nanofibers with a hydrophobic polymer by a PECVD technique or an electrografting technique.

During the deposition step, the pressure is located between 0.1 and 3 mbars. A polysiloxane precursor (hexamethyl disiloxane, octamethyl cyclotetrasiloxane, hexamethyldisilane, diphenyl methylsilane, . . . ) or a carbofluorinated precursor is introduced into the chamber and diluted with carrier gas (Ar, He, H₂, . . . ). The thickness of the deposited nanofiber carpet is of the order of a hundred nanometers.

Further, it is worthwhile to note that this hydrophobic material, although intrinsically an electrical insulator, has not insignificant electric conduction properties when it is deposited as a thin layer on nanotubes.

The use of nanotubes covered with a hydrophobic polymer as electrodes may then be contemplated. In particular, the carpet of nanotubes before depositing the hydrophobic material may be structured as blocks isolated from each other and then each of these blocks may be covered with the hydrophobic polymer so as to reform a matrix of electrodes.

1. A device with a hydrophobic and/or lipophobic surface comprising a carpet of nanofibers wherein these nanofibers are totally cladded with a hydrophobic and/or lipophobic continuous polymer film, and wherein the surface between these nanofibers is covered with a layer of this same polymer.

2. The device according to claim 1, wherein the nanofibers are carbon nanofibers.

3. The device according to claim 1, wherein the polymer film is polysiloxane or a carbofluorinated polymer.

4. A method for making a device with a hydrophobic and/or lipophobic surface which comprises a step for depositing nanofibers on a surface of said device, characterized in that it subsequently includes a step for cladding these nanofibers with a hydrophobic and/or liphobic polymer by a dry physical deposition technique, or by an electrografting technique.

5. The method according to claim 4, wherein the following steps are performed:
a step for depositing carbon nanofibers on a surface of a part, the step successively comprising:
depositing a catalyst by a PVD method, a target consisting of catalytic material being bombarded by a flux of ionized argon, the thereby ejected atoms from the target covering this surface, and
introducing the thereby covered part into a CVD oven in vacuo in order to achieve deposition of carbon nanofibers, the catalyst being first of all transformed into drops under the effect of the rise in temperature of the part, a hydrocarbon precursor being then introduced into the chamber, the growth of carbon nanofibers being performed at the location where the catalyst is transformed into drops, and
a step for cladding nanofibers with a hydrophobic polymer by a PECVD technique or an electrografting technique.
